(19) United States
(12) Patent Application Publication
(10) Pub. No.: US 2025/0360565 A1
(43) Pub. Date: Nov. 27, 2025

(54) DATA-BASED SYSTEM FOR OPTIMIZING POWDER BED FUSION ADDITIVE MANUFACTURING PROCESS

(71) Applicant: Korea Electronics Technology Institute, Seongnam-si (KR)

(72) Inventors: Hye In LEE, Anyang-si (KR); Hwa Seon SHIN, Yongin-si (KR); Jae Ho SHIN, Hanam-si (KR); Sung Hwan CHUN, Seoul (KR); Sung Hun PARK, Seoul (KR)

(73) Assignee: Korea Electronics Technology Institute, Seongnam-si (KR)

(21) Appl. No.: 18/721,068

(22) PCT Filed: Dec. 14, 2022
(86) PCT No.: PCT/KR2022/020290

§ 371 Date: Jul. 29, 2025

(30) Foreign Application Priority Data
Dec. 17, 2021 (KR) 10-2021-0181563

(51) Int. Cl. B22F 10/85; B22F 10/28; B22F 10/31; B22F 10/32; B22F 10/36; B33Y 10/00; B33Y 40/00; B33Y 50/02

(52) U.S. Cl. CPC B22F 10/85; B22F 10/28; B22F 10/31; B22F 10/32; B22F 10/36; B33Y 10/00; B33Y 50/02; B33Y 40/00

(57) ABSTRACT

Provided are a system and a method for optimizing a process on the basis of data collected in a powder bed fusion (PBF) additive manufacturing process. A system for optimizing an additive manufacturing process, according to an embodiment of the present invention, comprises: a data collection unit for classifying, by layer, data on process variables collected during an output preparation step and an output step of a PBF additive manufacturing process; a storage unit for storing the data classified by layer by means of the data collection unit; a classification unit for determining whether output is successful for each layer; and an analysis unit for analyzing the process variables for process optimization on the basis of the result of determining whether output is successful for each layer. Therefore, data generated during the output preparation step and the output step of the PBF additive manufacturing process are collected and accumulated, and guiding for optimizing the output step is performed on the basis of the collected and accumulated data, and thus output trial and error can be reduced and output stability of a portion dependent on equipment status can be enhanced.

### TECHNICAL FIELD

The disclosure relates to a system and a method for optimizing a powder bed fusion (PBF) additive manufacturing process, and more particularly, to a system and a method for optimizing a process based on data which is collected in a PBF additive manufacturing process.

### BACKGROUND ART

An additive manufacturing process may have various, complex problems in a manufacturing process due to its characteristic of depositing materials layer by layer.

Particularly, a powder bed fusion (PBF) method irradiates lasers to a metallic material existing in the form of powder along an output path, and has a high difficulty in manufacturing due to irregular heat characteristics.

In addition, the PBF method shows different characteristics by material and equipment, and there is a problem that much time is required even if a specialist is put to optimize a process.

In addition, there may be difficulty in optimizing a process even by undergoing trial and error multiple times. There are many factors that cause an error in the manufacturing process and there is a problem that it cannot be identified when the error occurs and what causes the error in a state where manufacturing is completed. For example, causes of the error may be a machine (equipment) error, an environmental variable (oxygen saturation, humidity, temperature, etc.).

In addition, at a process setting step for material supply, recoater speed, laser heat input capacity, a material surface should be directly cut or nondestructive testing such as CT should be performed in order to check quality of a corresponding output material after manufacturing is completed. However, this causes a problem that much time and much cost are required.

To overcome such problems, an equipment company may establish a monitoring system and enable a user to check an output status in real time, and may record log data. However, this method does not influence an output preparation step at which process variables are inputted, and has limitations to preventing problems.

### DISCLOSURE

### Technical Problem

The disclosure has been developed in order to address the above-discussed deficiencies of the prior art, and an object of the disclosure is to provide a system and a method which collect and accumulate data generated in an output preparation step and an output step of a PBF additive manufacturing process, and guide for optimization of the output step based on the data.

### Technical Solution

According to an embodiment of the disclosure to achieve the above-described object, an additive manufacturing process optimization system may include: a data collection unit configured to classify, by layer, data related to process variables which is collected in an output preparation step and an output step of a powder bed fusion (PBF) additive manufacturing process; a storage unit configured to store the data which is classified by layer through the data collection unit; a classification unit configured to determine whether output is successful for each layer; and an analysis unit configured to analyze a process variable for process optimization based on a result of determining whether output is successful for each layer.

In addition, the data collection unit may collect data related to an output path and a process variable for each output path in the output preparation step of the additive manufacturing process, and may collect sensing data of an environment sensor attached to additive manufacturing equipment, and equipment log data on a layer basis in the output step of the additive manufacturing process.

In addition, the classification unit may determine whether output is successful for each layer, and may add a result of determining whether output is successful for each layer to the data stored by layer.

In addition, the classification unit may determine whether there is an error by comparing an image edge detection result after outputting and a real output path, and, when there is an image edge detection result after a material is coated, may assume warping and may determine a layer from which an image edge is detected as output failure.

In addition, when a process optimization step is performed through the analysis unit, the classification unit may determine whether output is successful for each layer by using image data generated in the output step of the additive manufacturing process, the sensing data of the environment sensor, and the equipment log data.

When process variables are inputted to the output path, the analysis unit may use a geometrical shape as a feature value and may determine and output a setting value of a process variable that has highest similarity among existing output success data.

When there exists output success data that has the same output cross-sectional area of a specific layer among the existing output success data, the analysis unit may output a recoater setting value included in the output success data having the same output cross-sectional area of the specific layer. When there exists output success data that has the same patch surface area of a specific output path among the existing output success data, the analysis unit may output a fume pressure value included in the output success data having the same patch surface area of the specific output path. When there exists success data that has the same output pattern as a specific output pattern among the existing output success data, the analysis unit may output setting values of a laser speed and a laser power included in the success data of the same output pattern.

In addition, when it is determined that a material is not uniformly coated based on sensing data of an equipment sensor and an image analysis result of an output result, the analysis unit may output a recommendation value for an equipment recoater speed. When it is determined that oxygen saturation included in the sensing data of the environment sensor is higher than a pre-set first threshold value, and sparks occur more times than a pre-set second threshold value as a result of image analysis of the output result, the analysis unit may output a recommendation value for argon gas concentration of an equipment process.

In addition, the analysis unit may monitor the sensing data of the environment sensor and the equipment log data which are collected in the output step of the additive manufacturing process in real time, and, when sensing data of the environment sensor and equipment log data that have similarity of a third threshold value or higher to data classified as output failure data and stored are detected, the analysis unit may output a warning alarm, and may output a setting value of an equipment process included in output success data that has the same geometrical feature value of the output path or has similarity of a threshold value or higher.

According to another embodiment of the disclosure, an additive manufacturing process optimization method may include: a step of classifying, by layer through an additive manufacturing process optimization system, data related to process variables which is collected in an output preparation step and an output step of a powder bed fusion (PBF) additive manufacturing process, and storing the classified data; a step of determining, by the additive manufacturing process optimization system, whether output is successful for each layer; and a step of analyzing, by the additive manufacturing process optimization system, a process variable for process optimization based on a result of determining whether output is successful for each layer.

According to still another embodiment of the disclosure, a computer readable recording medium may have a computer program recorded thereon to perform an additive manufacturing process optimization method, the method including: a step of classifying, by layer through an additive manufacturing process optimization system, data related to process variables which is collected in an output preparation step and an output step of a powder bed fusion (PBF) additive manufacturing process, and storing the classified data; a step of determining, by the additive manufacturing process optimization system, whether output is successful for each layer; and a step of analyzing, by the additive manufacturing process optimization system, a process variable for process optimization based on a result of determining whether output is successful for each layer.

According to yet another embodiment of the disclosure, an additive manufacturing process optimization system may include: a storage unit configured to classify and store, by layer, data related to process variables which is collected in an output preparation step and an output step of a powder bed fusion (PBF) additive manufacturing process, and a result of determining whether output is successful for each layer; and an analysis unit configured to analyze a process variable for process optimization of a specific output path based on a result of determining whether output is successful for each layer, and to determine and output a setting value of a process variable that has highest similarity among existing output success data.

### Advantageous Effects

As described above, according to embodiments of the disclosure, by collecting and accumulating data generated in an output preparation step and an output step of a PBF additive manufacturing process and guiding for optimization of the output process based on the data, output trial and error may be reduced and output stability of a portion dependent of a status of equipment may be enhanced.

### DESCRIPTION OF DRAWINGS

FIG. 1 is a view provided to explain a data-based PBF additive manufacturing process optimization system according to an embodiment of the disclosure;

FIG. 2 is a view provided to explain a data collection unit in detail according to an embodiment of the disclosure;

FIG. 3 is a view provided to explain an analysis unit in detail according to an embodiment of the disclosure;

FIG. 4 is a view illustrating data related to process variables which is stored in a storage unit according to an embodiment of the disclosure; and

FIG. 5 is a view provided to explain a data-based PBF additive manufacturing process optimization method according to an embodiment of the disclosure.

### BEST MODE

Hereinafter, the disclosure will be described in more detail with reference to the drawings.

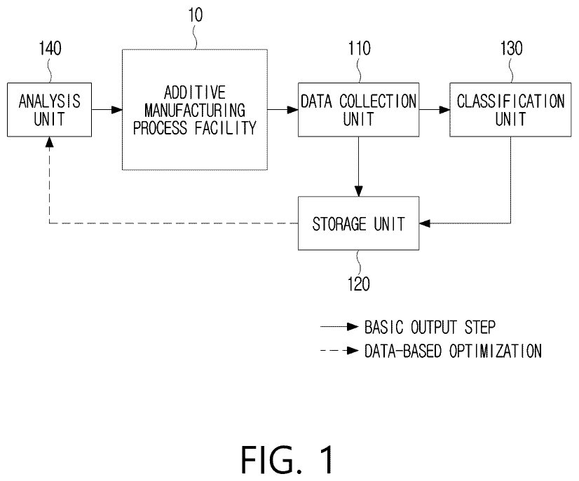

FIG. 1 is a view provided to explain an additive manufacturing process optimization system according to an embodiment of the disclosure.

A data-based PBF additive manufacturing process optimization system (hereinafter, referred to as an “additive manufacturing process optimization system”) according to an embodiment is provided to collect and accumulate data which is generated in an output preparation step and an output step of the PBF additive manufacturing process, and to guide for optimization of the output step based on the data.

To achieve this, the additive manufacturing process optimization system may include a data collection unit 110, a storage unit 120, a classification unit 130, and an analysis unit 140.

The data collection unit 110 may collect data which is related to process variables in an output preparation step and an output step of a PBF additive manufacturing process facility 10, and may classify the data by layer of a 3D model.

Here, the data related to the process variables may include path information, path process value, equipment process value, sensing data of an environment sensor, equipment log data, image data, etc.

The storage unit 120 may store data which is collected through the data collection unit 110 and is classified by layer.

The classification unit 130 may determine whether output is successful for each layer, and may generate output success data or output failure data.

For example, the classification unit 130 may determine whether there is an error by comparing an image edge detection result after outputting of the additive manufacturing process, and a real output path, and may generate output success data or output failure data.

In addition, the classification unit 130 may add the generated output success data or output failure data to the data that is stored by layer, and may store the data in the storage unit 120.

That is, the classification unit 130 may determine whether output is successful for each layer, and may add the result of determining whether output is successful for each layer to the data that is stored by layer, and may store the data in the storage unit 120.

The analysis unit 140 may analyze process variables for process optimization, based on the result of determining whether output is successful for each layer.

Specifically, the analysis unit 140 may analyze the process variables for process optimization, and may recommend an equipment process variable when the additive manufacturing process facility proceeds with the output step.

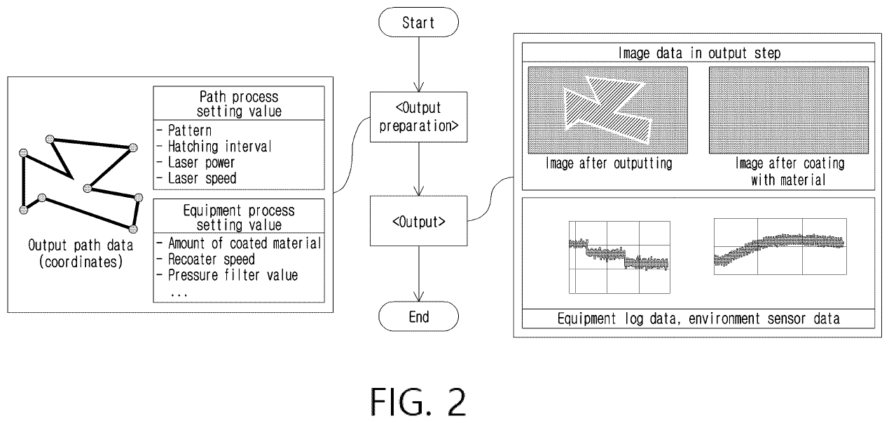

FIG. 2 is a view provided to explain the data collection unit 110 according to an embodiment of the disclosure.

As described above, the data collection unit 110 according to an embodiment may collect data related to process variables in an output preparation step and an output step of a PBF additive manufacturing process, and may classify the data by layer.

Specifically, the data collection unit 110 may collect data related to an output path and to process variables for each output path in the output preparation step of the additive manufacturing process.

In this case, the data related to the process variables for each output path may include a setting value of a path process which includes a pattern, a hatching interval, laser power and laser speed, and a setting value of an equipment process which includes an amount of coated material, a recoater speed, a pressure filter value.

In addition, the data collection unit 110 may collect sensing data of an environment sensor attached to the additive manufacturing equipment, and equipment log data on a layer basis in the output step of the additive manufacturing process.

When the data related to the process variables, which is collected in the output preparation step and the output step of the additive manufacturing process, is classified by layer through the data collection unit 110 and stored in the storage unit 120, the classification unit 130 may classify the success/failure in outputting for each layer, and then, may update the data accumulated on a layer basis and may store the updated data in the storage unit 120.

For example, the classification unit 130 may classify the success/failure in outputting through image data generated in the output step, and may determine whether output is successful for each layer by using environment sensor data and equipment log data in a state where a data-based optimization step is performed.

That is, when the process optimization step is performed through the analysis unit 140, the classification unit 130 may determine whether output is successful for each layer by using image data generated in the output step of the additive manufacturing process, sensing data of the environment sensor, and equipment log data.

In addition, the classification unit 130 may determine whether there is an error by comparing an image edge detection result after outputting of the additive manufacturing process and a real output path, and, when there is an image edge detection result after a material is coated, the classification unit 130 may assume warping which causes an output material to be bent and curl up due to heat, and may determine the layer from which the image edge is detected as output failure.

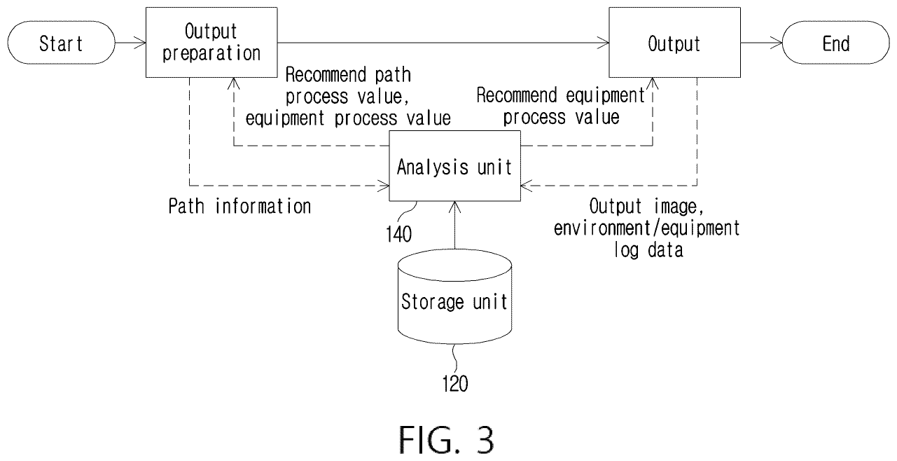

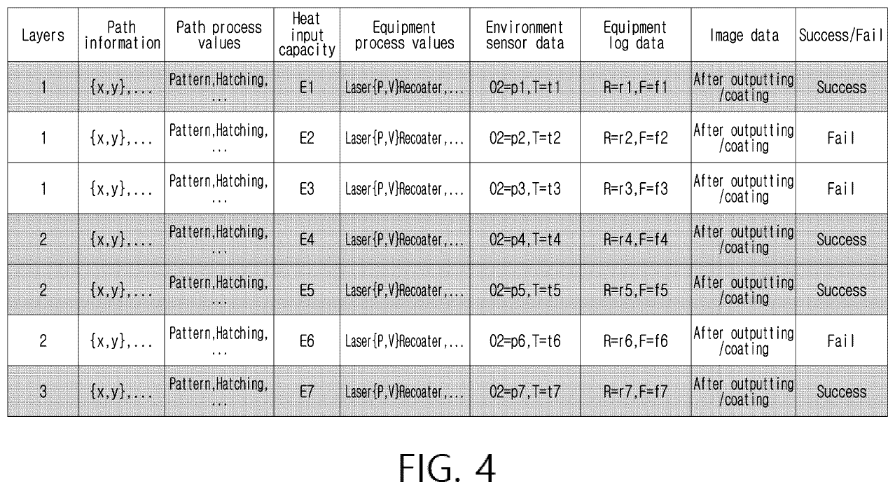

FIG. 3 is a view provided to explain the analysis unit 140 in detail according to an embodiment of the disclosure, and FIG. 4 is a view illustrating data related to pross variables which is stored in the storage unit 120 according to an embodiment of the disclosure.

The analysis unit 140 according to an embodiment may analyze process variables for process optimization based on the result of determining whether output is successful for each layer as described above.

That is, the analysis unit 140 may output a recommendation setting value for process optimization by using the collected data and the classified output success data or output failure data for each layer.

The analysis unit 140 may output a recommendation setting value for the equipment process by using the collected data and the classified output success data or output failure data for each layer in order to recommend a recommendation setting value for process optimization when inputting process variables into the output path in the output preparation step.

Specifically, when process variables are inputted to the output path, the analysis unit 140 may use a geometrical shape as a feature value and may determine a setting value of a process variable that has highest similarity among existing output success data, and may output the determined setting value.

For example, when there exists output success data that has the same output cross-sectional area of a specific layer among the existing output success data, the analysis unit 140 may output a recoater setting value included in the output success data having the same output cross-sectional area of the specific layer.

In another example, when there exist output success data that has the same patch surface area of a specific output path among the existing output success data, the analysis unit 140 may output a fume pressure value included in the output success data having the same patch surface area of the specific output path.

In yet another example, when there exists success data that has the same output pattern as a specific output pattern among the existing output success data, the analysis unit 140 may output setting values of a laser speed and laser power included in the success data of the same output pattern.

The analysis unit 140 may output a recommendation setting value for the equipment process in the output step.

For example, when it is determined that a material is not uniformly coated, based on sensing data of an equipment sensor and an image analysis result of an output result in the output step, the analysis unit 140 may output a recommendation value for an equipment recoater speed, and may guide the equipment recoater speed to be adjusted to the recommendation value for the equipment recoater speed.

In another example, when oxygen saturation included in sensing data of the environment sensor is higher than a pre-set first threshold value in the output step and it is determined that sparks occur more times than a pre-set second threshold value through image analysis of the output result, the analysis unit 140 may output a recommendation value for argon gas concentration of the additive manufacturing equipment, and may guide the argon gas concentration of the equipment to reach the recommendation value for the argon gas concentration.

The analysis unit 140 may monitor environment sensor data and equipment log data which are collected in the output step in real time, and, when sensing data of the environment sensor and equipment log data that have similarity of a third threshold value or higher to data classified as output failure data and stored, the analysis unit 140 may output a warning alarm and may output a setting value of the equipment process included in output success data that has the same geometrical feature value of the output path or has similarity of a threshold value or higher.

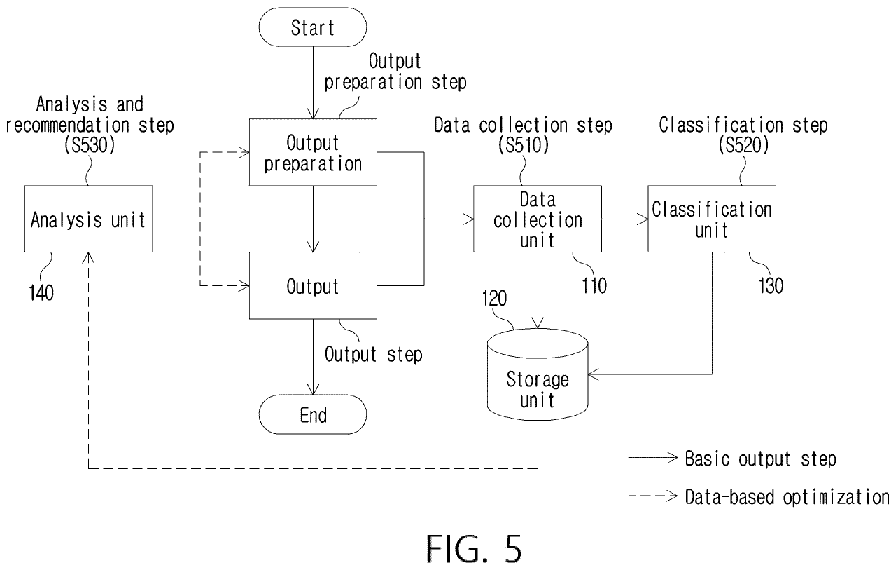

FIG. 5 is a view provided to explain a data-based PBF additive manufacturing process optimization method according to an embodiment of the disclosure.

The data-based PBF additive manufacturing process optimization method (hereinafter, referred to as an “additive manufacturing process optimization method”) according to an embodiment may be executed by the additive manufacturing process optimization system described above with reference to FIGS. 1 to 4.

Specifically, the additive manufacturing process optimization method according to an embodiment may collect, through the data collection unit 110, data related to process variables which is generated in an output preparation step and an output step of a PBF additive manufacturing process (S510), may classify the data by layer and store the data in the storage unit 120.

The additive manufacturing process optimization method may determine whether output is successful for each layer through the classification unit 130.

Specifically, the classification unit 130 may generate output success data or output failure data by determining whether output is successful for each layer (S520), and may add the generated output success data or output failure data to the data stored by layer, and may store the data in the storage unit 120.

In addition, the additive manufacturing process optimization method may analyze process variables for process optimization, based on the result of determining whether output is successful for each layer, through the analysis unit 140.

Specifically, the analysis unit 140 may analyze process variables for process optimization, and may recommend a setting value of an equipment process when an additive manufacturing process facility proceeds with the output step (S530).

By collecting and accumulating data generated in the output preparation step and the output step of the PBF additive manufacturing process and guiding for optimization of the output process based on the data, output trial and error may be reduced and output stability of a portion dependent of a status of equipment may be enhanced.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. An additive manufacturing process optimization system comprising:
a data collection unit configured to classify, by layer, data related to process variables which is collected in an output preparation step and an output step of a powder bed fusion (PBF) additive manufacturing process;
a storage unit configured to store the data which is classified by layer through the data collection unit;
a classification unit configured to determine whether output is successful for each layer; and
an analysis unit configured to analyze a process variable for process optimization based on a result of determining whether output is successful for each layer.

2. The additive manufacturing process optimization system of claim 1, wherein the data collection unit is configured to:
collect data related to an output path and a process variable for each output path in the output preparation step of the additive manufacturing process; and
collect sensing data of an environment sensor attached to additive manufacturing equipment, and equipment log data on a layer basis in the output step of the additive manufacturing process.

3. The additive manufacturing process optimization system of claim 2, wherein the classification unit is configured to determine whether output is successful for each layer, and to add a result of determining whether output is successful for each layer to the data stored by layer.

4. The additive manufacturing process optimization system of claim 3, wherein the classification unit is configured to:
determine whether there is an error by comparing an image edge detection result after outputting and a real output path; and
when there is an image edge detection result after a material is coated, assume warping and determine a layer from which an image edge is detected as output failure.

5. The additive manufacturing process optimization system of claim 3, wherein the classification unit is configured to, when a process optimization step is performed through the analysis unit, determine whether output is successful for each layer by using image data generated in the output step of the additive manufacturing process, the sensing data of the environment sensor, and the equipment log data.

6. The additive manufacturing process optimization system of claim 3, wherein the analysis unit is configured to, when process variables are inputted to the output path, use a geometrical shape as a feature value and determine and output a setting value of a process variable that has highest similarity among existing output success data.

7. The additive manufacturing process optimization system of claim 6, wherein the analysis unit is configured to:
when there exists output success data that has the same output cross-sectional area of a specific layer among the existing output success data, output a recoater setting value included in the output success data having the same output cross-sectional area of the specific layer;
when there exists output success data that has the same patch surface area of a specific output path among the existing output success data, output a fume pressure value included in the output success data having the same patch surface area of the specific output path; and
when there exists success data that has the same output pattern as a specific output pattern among the existing output success data, output setting values of a laser speed and a laser power included in the success data of the same output pattern.

8. The additive manufacturing process optimization system of claim 6, wherein the analysis unit is configured to:
when it is determined that a material is not uniformly coated based on sensing data of an equipment sensor and an image analysis result of an output result, output a recommendation value for an equipment recoater speed; and
when it is determined that oxygen saturation included in the sensing data of the environment sensor is higher than a pre-set first threshold value, and sparks occur more times than a pre-set second threshold value as a result of image analysis of the output result, output a recommendation value for argon gas concentration of an equipment process.

9. The additive manufacturing process optimization system of claim 6, wherein the analysis unit is configured to monitor the sensing data of the environment sensor and the equipment log data which are collected in the output step of the additive manufacturing process in real time, and, when sensing data of the environment sensor and equipment log data that have similarity of a third threshold value or higher to data classified as output failure data and stored are detected, output a warning alarm, and to output a setting value of an equipment process included in output success data that has the same geometrical feature value of the output path or has similarity of a threshold value or higher.

10. An additive manufacturing process optimization method comprising:
a step of classifying, by layer through an additive manufacturing process optimization system, data related to process variables which is collected in an output preparation step and an output step of a powder bed fusion (PBF) additive manufacturing process, and storing the classified data;
a step of determining, by the additive manufacturing process optimization system, whether output is successful for each layer; and
a step of analyzing, by the additive manufacturing process optimization system, a process variable for process optimization based on a result of determining whether output is successful for each layer.

11. A computer readable recording medium having a computer program recorded thereon to perform an additive manufacturing process optimization method, the method comprising:
a step of classifying, by layer through an additive manufacturing process optimization system, data related to process variables which is collected in an output preparation step and an output step of a powder bed fusion (PBF) additive manufacturing process, and storing the classified data;
a step of determining, by the additive manufacturing process optimization system, whether output is successful for each layer; and
a step of analyzing, by the additive manufacturing process optimization system, a process variable for process optimization based on a result of determining whether output is successful for each layer.

12. An additive manufacturing process optimization system comprising:
a storage unit configured to classify and store, by layer, data related to process variables which is collected in an output preparation step and an output step of a powder bed fusion (PBF) additive manufacturing process, and a result of determining whether output is successful for each layer; and
an analysis unit configured to analyze a process variable for process optimization of a specific output path based on a result of determining whether output is successful for each layer, and to determine and output a setting value of a process variable that has highest similarity among existing output success data.
